(19) United States
(12) Patent Application Publication
(10) Pub. No.: US 2006/0059480 A1
(43) Pub. Date: Mar. 16, 2006

(54) System and method for updating program

(75) Inventor: Tetsuo Kimoto, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 11/023,117

(22) Filed: Dec. 27, 2004

(30) Foreign Application Priority Data
Sep. 10, 2004 (JP) JP2004-263788

(51) Int. Cl. G06F 9/44

(52) U.S. Cl. 717/172

(57) ABSTRACT

A system for updating a program comprises a device to be updated with an update-program based on a program-update request including information of a requester and information for specifying the device, generated by the requester, and an authentication device for authenticating the requester, the authentication device including a receiving device for receiving the program-update request, a judging device for judging whether the information of the requester is identical with a pre-registered information, and a transmitting device for transmitting a program-update notice to the device based on the program-update request only when the program-update request is identical with the pre-registered information, wherein the device is changed into a status which can allow the device to update the program only when the device receives the program-update notice.

This application is based on patent application No. Tokugan 2004-263788 filed in Japan, the entire content of which is hereby incorporated by reference.

### BACKGROUND

1. Field of the Invention

The present invention relates to a system and method for updating programs via a network.

2. Description of the Related Art

In a device or an information processing apparatus operated by computer programs, sometimes the programs need to be updated for correcting problems or for adding new functions. In recent years, updated programs are downloaded from a server via a network.

For an example, in Japanese Patent Application Open to Public Inspection No. 2001-51810, disclosed is an image forming apparatus which acquires an updated program from a server for an external vendor according to e-mail when receiving e-mail requesting the updated programs from the external vendor.

In Japanese Patent Application Open to Public Inspection No. 2001-249815, disclosed is a network connecting apparatus which downloads a program from a server connected to a network based on an updating request received via a web-page. In this apparatus, the network address of the server storing the version number of firmware and related information are registered in advance. Each firmware version and a network address of a server storing related information are registered in a network connecting apparatus. And each firmware version is accessed based on a client's request and formed into a list by acquiring the each firmware version via a web page. A target firmware corresponding to the firmware version selected by a client via the list displayed on the client's browser is downloaded from the server.

Further, in Japanese Patent Application Open to Public Inspection No. H08-125794, disclosed is an image forming apparatus management system capable of updating the program of a client's image forming apparatus only when an authentication is correctly conducted by receiving a registered number inputted from the operation panel of the client's image forming apparatus via a public telephone line connected to the image forming apparatus management system.

A request for updating programs via e-mail and/or web-page can improve the efficiency of an updating process. However, since it is possible, whoever the requester is, to send e-mail conforming to a requested format or to access a certain web page to update a program, an intended, unlicensed or illegal program may be downloaded by an authorized person. Consequently the security of the system is not adequate. Specifically, in case of downloading programs via an open to public Internet site, it is necessary to pay adequate attention to the security of the system.

On the other hand, in a system which allows an operator to download a program only when a management apparatus successfully completes a registered number inputted from an operation unit of an image forming unit, a service person must visit the place where the image forming apparatus is located. Although it is possible to exclude an unauthorized operator, it is inconvenient in that remote control is not allowed.

### SUMMARY OF THE INVENTION

The present invention is proposed to solve the problems described above. An object of the present invention is to provide a program updating system and a method capable of giving the request for updating a program from the outside while maintaining security.

In accordance with one aspect of the present invention, a system for updating a program, comprises a device to be updated with an update-program based on a program-update request including information of a requester and information for specifying the device, generated by the requester, and an authentication device which authenticates the requester, the authentication device including, a receiving device which receives the program-update request, a judging device which judges whether or not the information of the requester is identical with a pre-registered information, and a transmitting device which transmits a program-update notice to the device based on the information for specifying the device only when the information of the requester is identical with the pre-registered information, wherein the device is shifted into a status which can allow the device to update the program only when the device receives the program-update notice.

In according another aspect of the present invention, a system for updating a program comprises an authentication device, and a device to be updated with an update-program based on a program-update request including information of a requester,

wherein the device comprises a receiving device which receives the program-update request, a first transmitting device which transmits the information of the requester to the authentication device, wherein the authentication device having a pre-registered information which authenticates the requester, comprises a judging device which judges whether or not the information of the requester received from the first transmitting device is identical with the pre-registered information, and a second transmission device which transmits a program-update notice to the device only when the judging device judges that the information of the requester is identical with the pre-registered information, wherein the device is shifted into a status which can allow the device to update the program only when the device receives the program-update notice.

In accordance with another aspect of the present invention, a system for updating a program, the system comprises a program storage device which stores an update-program, a device to be updated with an update-program based on a program-update request including information of a requester and information of the device, a receiving device which receives the program-update request inputted in an external device at outside of the receiving device, a judging device which judges whether or not the information of the requester received by the receiving device is identical with pre-registered information, and a program updating device which controls so that the device downloads the update-program from the program storage device via the network only when the information of the requester is identical with the pre-registered information.

### BRIEF DESCRIPTION OF THE DRAWINGS

FIG. 1 is an example of a system configuration and information flow of the program updating system of this invention.

FIG. 2 is a block diagram of each device configuring the program updating system of this invention.

FIG. 3 is an example of a CE information registration table stored in a storage device of an authentication server.

FIG. 4 is a flowchart of the steps for a program update of the program updating system shown in FIG. 1.

FIG. 5 is e-mail communication between the CE device of a program-update requester and an authentication device.

FIG. 6 is an example of an update request input displayed on a screen of the CE device used when sending program update request e-mail.

FIG. 7 shows an example of data of a confirmation e-mail message.

FIG. 8 is an example of contents of a confirmation-e-mail message.

FIG. 9 shows information flow of the program updating system when the authentication server and program server are combined into one configuration.

FIG. 10 shows information flow of the program updating system when a digital copy machine is arranged so as to receive the program update request.

FIG. 11 is a flowchart of a program update executed in the program updating system shown in FIG. 10.

FIG. 12 is information flow of a program updating system when an authentication process is executed in an authentication server via a program server.

FIG. 13 is information flow of a program updating system when a program is downloaded from a program server via an authentication server.

### DESCRIPTION OF THE PREFFERED EMBODIMENT

Based on drawings, an embodiment of the present invention will be described below.

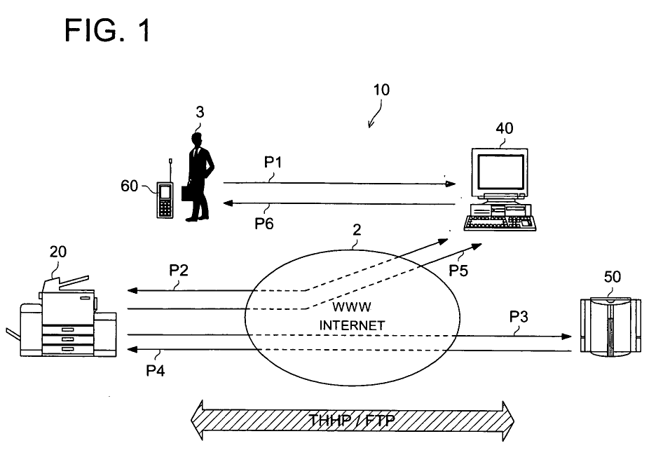

FIG. 1 shows an example of a configuration of program updating system 10 as an embodiment of the present invention. Program updating system 10 comprises digital copy machine 20, authentication server 40 and program sever 50 which are connected with each other via the Internet 2.

Program updating system 10 is a system which updates a program of digital copy machine 20, being a device to be updated with the update-program for which a person who requests a program update, such as a CE (Customer Engineer) for conducting maintenance, checking and administrating digital copy machine 20, from a cellular phone or a CE device such as a computer set at a sales office.

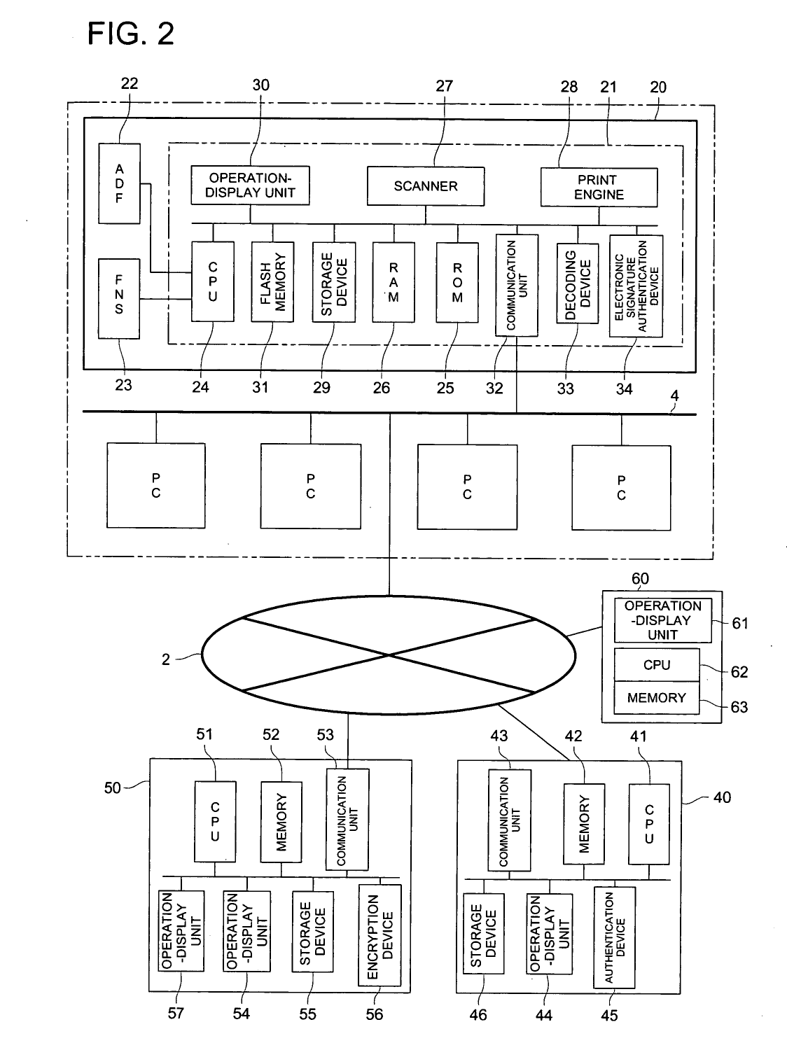

FIG. 2 is a block diagram of each device configuring program updating system 10. Digital copy machine 20 is connected to LAN 4 (Local Area Network) in an office together with many PCs (Personal Computer). LAN 4 is electrically connected to Internet 2 via a firewall (not shown). Digital copy machine 20 comprises copy machine main body 21, automatic document feeder (ADF) 22 and finisher (FNS) 23.

Copy machine main body 21 incorporates a CPU (Central Processing Unit) 24 as a device for controlling operations, and is connected to several kinds of devices. ROM (Read Only Memory) 25 stores an initializing program being executed by CPU 24 and a program used for updating a program, etc. RAM (Random Access Memory) 26 functions as a work memory or a page memory capable of storing at lease one page of image data necessary for a rotation process, etc.

Operation-display unit 30 comprises an LCD (Liquid Crystal Display) having a touch panel on the surface thereof and several kinds of operation switches. It displays several kinds of operational guides and status displays to an operator, and accepts input operations of the operator.

Scanner 27 scans an image of a document and takes in digitized image data corresponding to the scanned image. Scanner 27 comprises a light source to irradiate the document, a line image sensor to read one line of the image in the document lateral direction, a moving device to move the document in the longitudinal direction to read the next line, a lens and a mirror for guiding reflected light from the document to the line image sensor whereby a digital image is formed. The line image sensor is configured by a CCD (Charge Coupled Device). Analog image signals outputted from the line sensors are converted into a digital signal (A/D conversion) and stored as digital image data.

Print engine 28 forms an image corresponding to image data onto a paper recording sheet. Print engine 28 which is utilizing as an electronic photograph processor, is configured as a laser beam printer. Print engine 28 comprises a conveyance apparatus for the paper recording sheets, a photosensitive drum, a laser unit, a developing apparatus, a transfer-separating apparatus, a cleaning apparatus and a fixing apparatus.

Storage device 29 is a large capacity memory apparatus to store image data, etc. In this embodiment, a hard disk drive (HDD) is adopted.

Flash memory 31 is a nonvolatile and rewritable memory to store operational programs and data. Flash memory 31 stores programs downloaded from program server 50. Communication section 32 communicates with external devices and apparatuses via LAN 4 and Internet 2. Decoding device 33 decodes encrypted programs being sent. Electronic signature authentication device 34 authenticates the electronic signature of the sender of the program.

CE device 60 is a device by which program update requester 3 sends a program update request and comprises operation-display section 61, CPU 62 and memory 63. The program update request outputted from CE device 60 includes requester information indicating a person who placed the request and the program update request information. The requester information comprises ID (Identification) of person who requests a program update and a password. The program update request information comprises information designating a device to be updated with the update-program (ID of the device to be updated with the update-program) and information designating a program to be updated. CE device 60 sends the program update request to authentication server 40. The sending method of the program update request depends on the type of CE device 60 and they may be e-mail, a web (World Wide Web) page, etc. In case a party who receives the program update request via telephone incorporating an automatic telephone answering machine, CE device 60 may be a telephone and program update requester 3 can input the information vocally.

Authentication server 40 as an authentication device contains CPU 41, memory 42, communication unit 43, operation-display unit 44, authentication device 45 and storage device 46. CPU 41 controls operations of authentication server 40. Memory 42 comprises a ROM, which stores operational programs of authentication server 40, and a RAM as a working memory. Communication unit 43 is connected to program server 50, digital copy machine 20 and CE device 60 via LAN 4, Internet 2 and telephone lines. Operation-display unit 44 comprises a display apparatus, a keyboard and a pointing device, for example, a computer mouse.

Authentication device 45 determines whether the requester is a person who has proper authority of the program update based on the requester information included in the program update request received via CE device 60. Storage device 46 stores information of requester who has proper authority of the program update in advance. Authentication device 45 judges whether storage device 46 includes registered information being identical with the received requester information. Authentication is completed when the registered information has been included in storage device 46.

Program server 50, as a program storage device, contains CPU 51, memory 52, communication unit 53, operation-display unit 54, storage device 55, encryption device 56 and electronic signature generating device 57. CPU 51 controls operations of program server 50. Memory 52 comprises a ROM storing operational programs of program server 50 and a RAM as a working memory. Communication unit 53 is connected to program server 50 and digital copy machine 20, etc via LAN 4 and Internet 2. Operation-display unit 54 comprises a display device, a keyboard and a pointing device, such as, a computer mouse.

Encryption device 56 stores several kinds of programs to be sent to the device to be updated with the update-program, such as digital copy machine 20. Encryption device 56 encrypts a program when the program is sent to the device to be updated of program updating system 10. Electronic signature generation device 57 generates an electronic signature to verify the sender of the program.

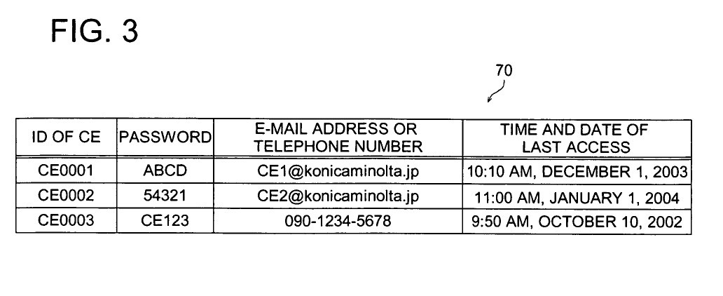

FIG. 3 is an example of registered CE information table 70 stored in storage device 46 of digital copy machine 20. Registered CE information table 70 includes ID information of a requester who has proper authority to the update programs. Specially, registered is the ID (identification) of the CE corresponding to a password, an e-mail address and a telephone number and the time and date of last access.

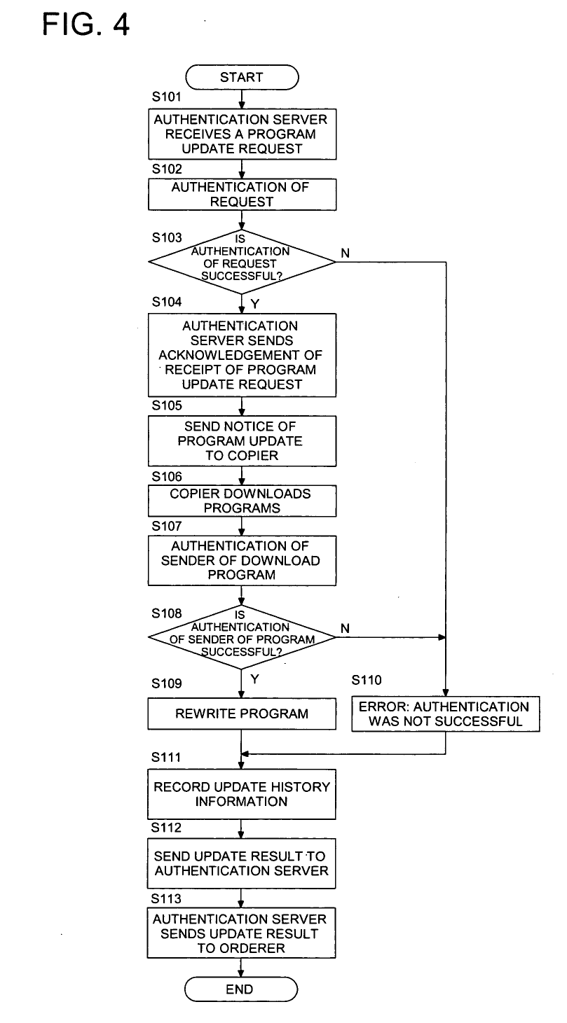

FIG. 4 is a flowchart of a program updating process of program updating system 10 shown in FIG. 1. Program update requester 3 makes a program update request and sends it to authentication server 40 when updating a program. (See P1 shown in FIG. 1) The program update request can be placed via e-mail, a Web site for receiving a program update request, provided by authentication server 40, an automatic telephone answering system provided by authentication, and a direct input from operation-display unit 44 of authentication server 40.

When authentication sever 40 receives the program update request (Step 101), authentication server 40 authenticates the requester (a sender) of the program update request. Here, authentication server 40 determines whether the combination of the ID of the CE and the password in the requester information of the program-update request which has been received is stored in registered CE information 70 of storage device 46. When a combination being identical with the combination is found in registered CE information 70, the authentication server determines that the authentication has been successfully completed.

When the authentication is successfully completed (Step S103; Y), authentication server 40 notifies CE device 60 of the sender (requester) of the program-update request that the update request has been received (Step S104). The way of the notification may be e-mail, a receipt-completion-display on a Web-page and an automatic telephone answering system. When the program update request is directly inputted from operation-display unit 44 of authentication server 40, “A program update request has been completed” may be displayed on the screen of operation-display unit 44.

Further, authentication server 40 that successfully completes authentication sends a program update notice to a device to be updated (digital copy machine 20) which requests program update (Step S105, see P2 in FIG. 1). Digital copy machine 20 which has received the program update notice downloads the update program from program server 50 via Internet 2 (Step S106). In this situation, digital copy machine 20 sends a program-download requests to program server 50 (P3 in FIG. 1) then program sever 50 receives it and sends the program to the sender of the request (P4 in FIG. 1). The update program is sent by using HTTP (Hypertext Transfer Protocol) or FTP (File Transfer Protocol).

Incidentally, digital copy machine 20 sends a program download request to program server 50 only when receiving the program update notice from authentication server 40 and does not send the program download request when receiving the program update notice from other external devoces. Namely the digital copy machine 20 is shifted into the condition capable of receiving the update program only when receiving the program update notice from authentication server 40, not being shifted into the condition capable of receiving the program when receiving the program update notice from other external devices.

Digital copy machine 20 which has downloaded the update program authenticates an electronic signature, etc. whether program server 50 which has delivered the update program is authentic (Step S107). When the authentication is successfully completed (Step S108: Y), a current program is updated by the downloaded update program stored in flash memory 31 (Step 101).

When failing in the authentication of sender or the request (requester) (Step S103: N), or failing in the authentication of the sender of the program (Step 108: N) it comes to error of authentication-incomplete.

In any case of that the current program has been updated and the authentication is incomplete, update history information is recorded (Step S111) and digital copy machine 20 sends a program update result to authentication server 40 (Step S112, P5 in FIG. 1). Authentication server 40 which received the program update result sends the program update result to CE device 60 of the sender of program update (requester) (Step S113, P6 in FIG. 1). The way to send the program update result will be conducted via e-mail, the screen display in a Web page showing that the reception has been completed and/or an automatic telephone answering system, etc. Also when the program update request has been placed via a direct input of operation-display unit 44 of authentication server 40, the screen display may display that the reception has been completed.

As explained above, a program update requester sends a program update request to authentication server 40. Authentication server 40 sends program update request to a device to be updated only when the authentication is successfully completed. The device to be updated (digital copy machine 20) is shifted into the condition where the program can be downloaded only when receiving the program update request from authentication server 40. Consequently, the program update request from unauthorized person can be rejected and the security of program update can be enhanced.

Further, since digital copy machine 20 sends the program update result to authentication server 40, authentication server 40 can check whether the program of digital copy machine 20 is updated by an unauthorized program update request.

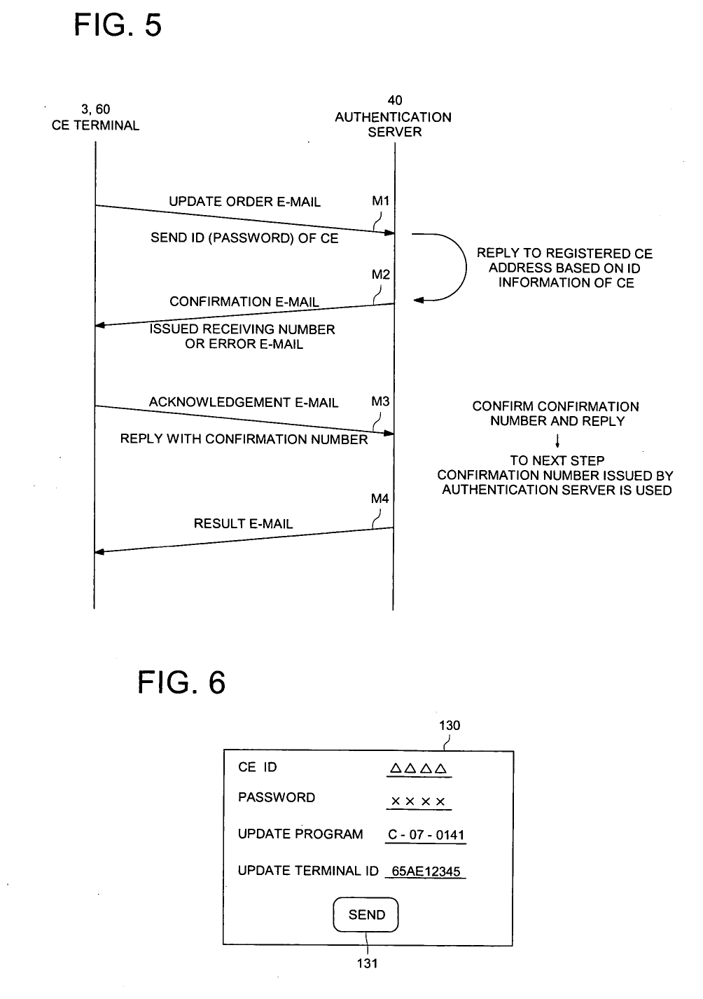

FIG. 5 is a flowchart showing correspondences between a CE device 60 of program update requester and authentication server 40 when the correspondences are sent via e-mails. The program update requester sends a program update request via e-mail from CE device 60 to authentication server 40 (M1).

FIG. 6 is an example of update request input screen 130 displayed in the display of CE device 60 when making program update request e-mail. The program update email including each information displayed in update request input screen 130 is sent to authentication server 40 by inputting the ID of the CE, a password, information designating an update program (ID, etc. of the update program) and information specifying a device to be updated (ID of the update device) and operating SEND button 131.

As shown in FIG. 5, authentication sever 40 authenticates the requester based on the ID of the CE and the password, etc. which are included in a receiving e-mail. When the authentication is successfully completed, acknowledgement e-mail is sent to the CE device 60 and when failing the authentication, error e-mail is sent to the CE device 60.

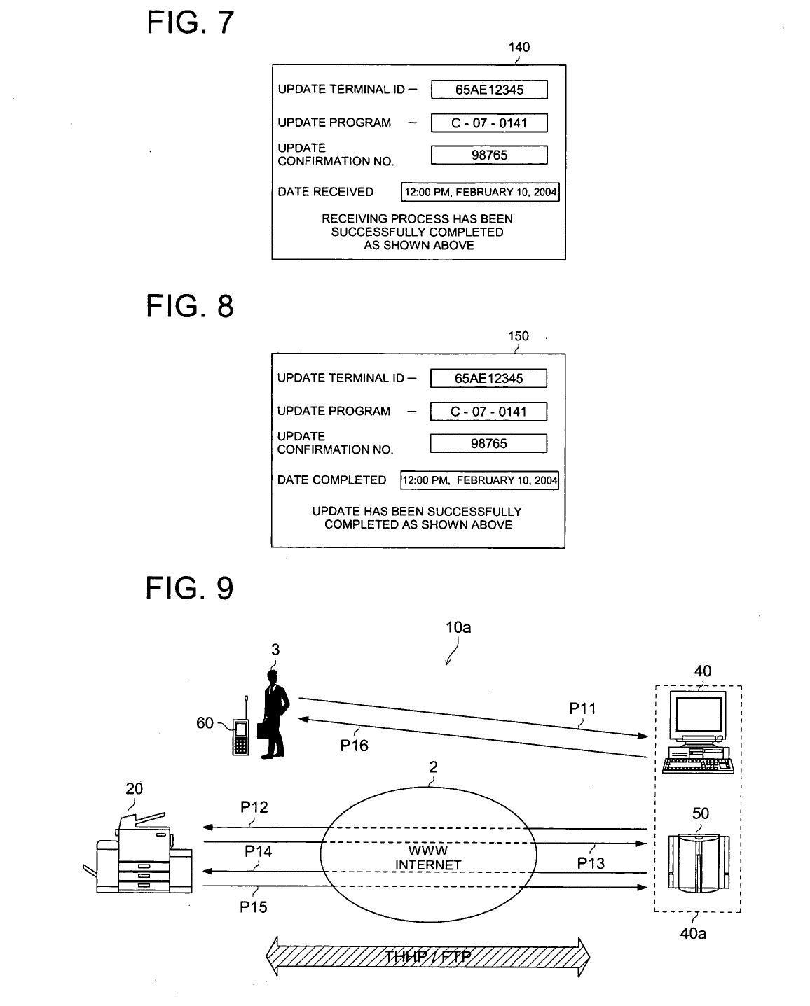

FIG. 7 is an example of the confirmation e-mail. Confirmation e-mail 140 including the device to be updated (ID of updated device) specified by the update request e-mail, information specifying the update program (ID of update program, etc.), the update-receiving number, the date and time showing when the request is received and the message showing that reception is completed, etc. is automatically issued.

As shown in FIG. 5, CE device 60, which receives the acknowledgement e-mail, sends an e-mail showing that the acknowledgement e-mail has been received to authentication server 40 (M3). After that, the program update request is specified by the update receiving number then a program update process is conducted.

When the program update process is completed or failed, authentication server 40 sends a result e-mail showing an update process result to CE device 60 (M4).

FIG. 8 is an example of the contents of result e-mail. Result e-mail 150 contains the ID of the updated device to which the program update has been conducted, ID of the updated program, the updated receiving number, time and date when the update process has been completed and a message showing that the update has been successfully completed, etc.

FIG. 9 shows program updating system 10a in which authentication server 40 shown in FIG. 1 and program server 50 are configured into one body. Authentication-program server 40a has functions which authentication server 40 shown in FIG. 1 and program server 50 contains. Other configurations and operations are the same as the system shown in FIGS. 1-8.

Program update requester 3 sends a program update request to authentication-program server 40a (P11). When authentication-program server 40a receives a program update request, authentication-program server 40a conducts an authentication process of a requester. When the authentication is successfully completed, authentication-program server 40a sends a program update notice to a device to be updated (digital copy machine 20), which is specified the program update request (P12). Digital copy machine 20 which received the program update notice sends a program download request to authentication-program server 40a (P13). Authentication-program server 40a, which received the program download request sends a update program in response to the program update notice (P14).

Digital copy machine 20 sends an update result to authentication-program server 40a after updating a program. Authentication-program server 40a, which received the update results sends an update result to CE device 60 for the sender of the program update request (requester) (P16).

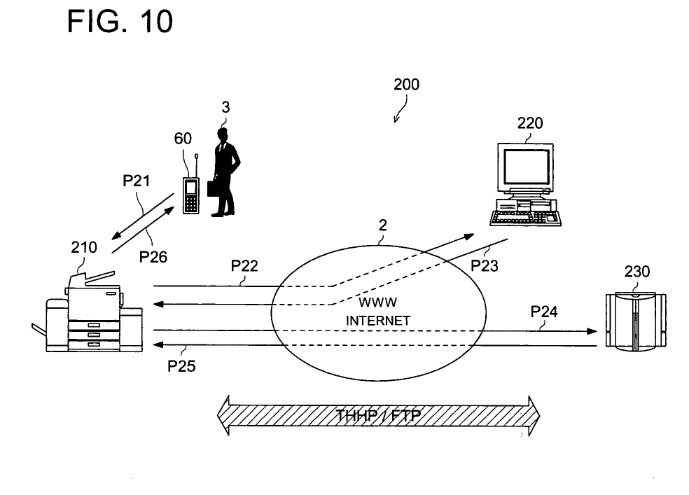

FIG. 10 shows program-updating system 200, which is the second embodiment of the present invention. In program-updating system 200, digital copy machine 210 is arrange so that when digital copy machine 210 receives a program update request from program update requester 3 (CE device 60), digital copy machine 210 requests an external authentication server 220 to authenticate a requester.

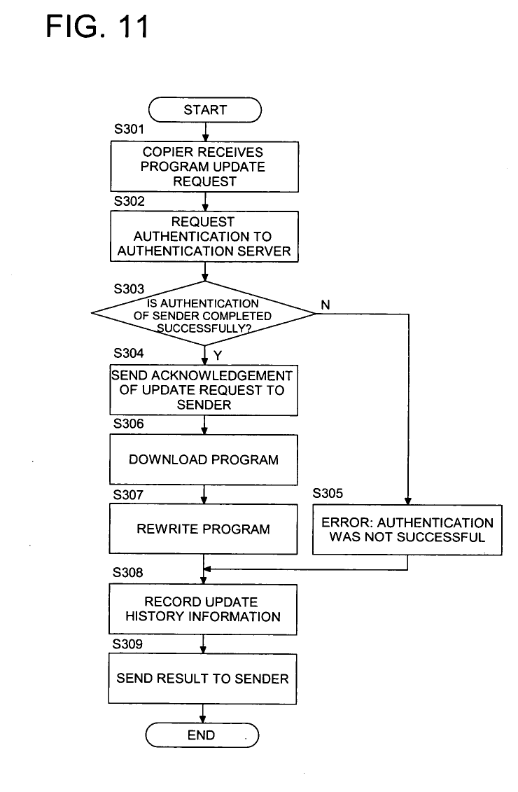

FIG. 11 is a flowchart of the process of a program update process performed by program updating system 200 shown in FIG. 10. Program update requester 3 makes a program update request by using CE device 60 and sends it to digital copy machine 210 when conducting a program update (P21 in FIG. 1). The program update request is inputted via e-mail, a Web page configured in digital copy machine 210 provided for receiving the program update request and an automatic telephone answering system which digital of digital copy machine 210. Other than these, the program update request may be inputted from an operation display unit of digital copy machine 210.

Digital copy machine 210 requests authentication server 220 to authenticate the requester by sending information included in the program update request (Step S302, P22 in FIG. 10) when digital copy machine 210 receives program update request (Step S301). Authentication server 220 determines whether the requester information received from digital copy machine 210 is identical with any requester information previously stored in authentication server 220. When the authentication is successfully completed (Step S303: Y), authentication server 220 sends an acknowledgement of a update request permitting digital copy machine 210 as an authentication requester (Step S304) to receive the program update request. When the authentication is failed (Step S303: N), authentication server 210 sends an authentication incomplete error notice to digital copy machine 220 (Step 305).

Digital copy machine 210 to which the program update confirmation is sent downloads an update program from program server 230 via Internet 2 (Step S306). Here, digital copy machine 210 sends a program download request to program server 230 (P24 in FIG. 10), program server 230 sends the update program to the sender of the program update request (P25 in FIG. 10).

Digital copy machine 210 which received the update program executes a program update process (Step S307).

Digital copy machine 210 may send a message that the program update request was successfully received to CE device 60 of the program update requester. Also, digital copy machine 210 may be arranged so that digital copy machine 210 checks whether program server 230 which delivered the update program is authentic by using electronic signature when digital copy machine 210 downloaded the update program, and the program update process is executed only when the authentication is successfully completed.

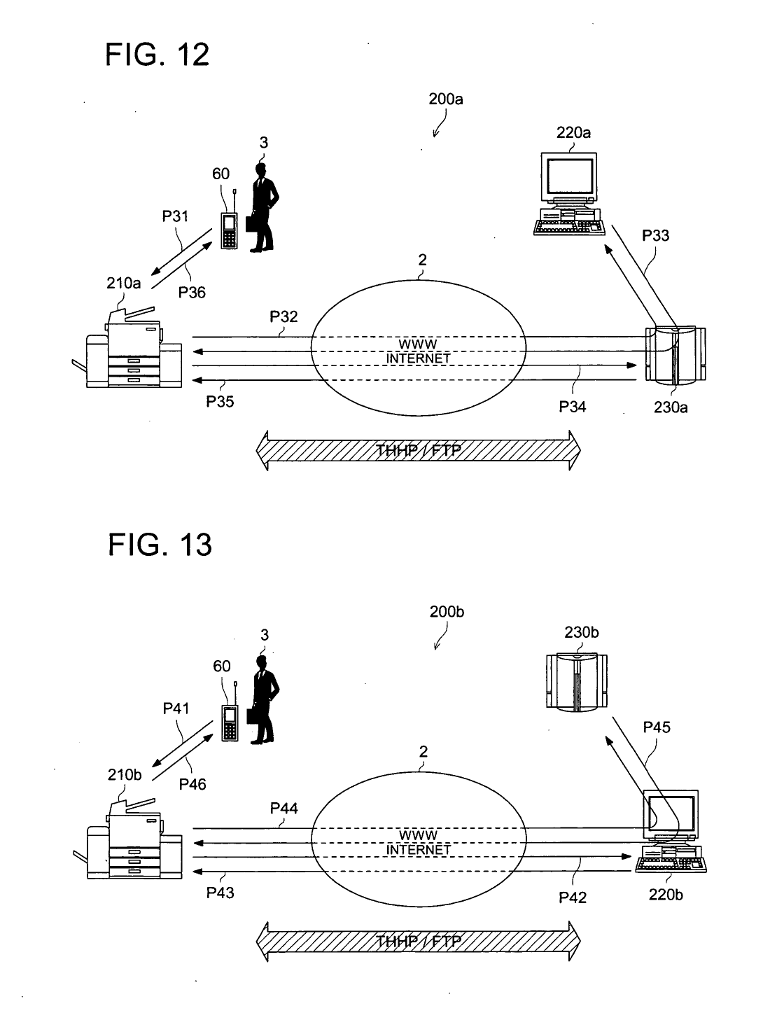

FIG. 12 shows program updating system 200a in which digital copy machine 210a is arranged so that digital copy machine 210 requests authentication server 220a to authenticate the program update requester via program server 230a. Program update requester 3 sends program update request to digital copy machine 210a (P31). Digital copy machine 210a requests authentication server 220a to authenticate the requester via program server 230a when receiving the program update request (P32). Authentication server 220a returns an authentication result to digital copy machine 210a via program server 230a.

Digital copy machine 210a sends a program download request to program server 230a when receiving a message that the authentication is successfully completed (P34). Program server 230a sends a update program to digital copy machine 210a in response to the request (P35). Digital copy machine 210a sends an update result to CE device of the requester 3 of the program update requester (P36) after completing an update operation.

FIG. 13 shows program updating system 200b in which digital copy machine 210b is arranged so that digital copy machine 210b accesses to program sever 230b via authentication server 220b. Program update requester 3 sends a program update request to digital copy machine 210b (P41). Digital copy machine 210b requests authentication server 220b to authenticate a requester (P42) when receiving the program update request and receives an authentication result from authentication server 220b (P43).

Digital copy machine 210b sends a program update request to program server 230b via authentication server 220b (P44) when receiving a message that authentication has successfully completed. In response to this, program server 230b sends an update program to digital copy machine 210b in response to the request via authentication server 220b (P45). Digital copy machine 210b sends an update result to CE device of program update requester 3 (P46) after completing a program update operation.

The embodiments of the present invention have been described above by using drawings. Concrete configurations are not limited to the embodiments. It is to be understood that various changes and modifications may be made without departing from the scope of the invention.

The location of a function to receive a program update request, a function to authenticate a requester and a device functioning to approve a program update in the system may be appropriately decided, and it is not limited to the examples shown as the embodiments. For example, in the configurations shown in FIGS. 10 and 13, a digital copy machine may have an authentication server function therein. In this case, the digital copy machine is arranged so that the digital copy machine, which has received a program update request from a CE device of a requester, authenticates the requester by an authentication function therein and requests a program server to download a program when successfully completing the authentication. As shown in FIGS. 10, 12 and 13, even in a configuration in which a digital copy machine receives a program update request for program update requester, an authentication server and a program server may be combined the same as shown in FIG. 9 into one body.

A message or notice to a program update requester may be configured so that the message is sent to show whether an authentication is successfully completed when completing the authentication other than sending an update result. The information for authenticating a requester may includes the address of the requester (an e-mail address and a telephone number, etc.)

A program update request may be configured so that when an update program is registered to a program server, the program server automatically sends a program update request from a program server other than sending it based on an operation by a CE (Customer Engineer).

In regard to a download program itself, in order to improve a security level, an alternation of the program may be checked and also an authentication of a sender may be performed. Further, the system may be configured so that the second server (a mirror server) automatically switches the operation when the server problems occur (communication traffic congestion) by proving a plurality of servers in the system.

A device to be updated updates a program by downloading the program from a program-storage device via a network. It may be possible to provide plural program storage devices for backup and distributed processing purposes.

In these embodiments, although several examples related to a program update of a digital copy machine have been explained, other than these examples, the device to be updated is not limited to the examples of the embodiments. It may be another device as long as a computer program operates the apparatus.

According to one aspect of the present invention, a person sends a request for updating a program to an authentication device. The authentication device conducts an authentication process to authenticate the requesting person and the authentication device issues a program update request to a device to be updated only when the authentication is successfully completed. Then the device to be updated updates a program only when receiving the program-update request from the authentication device. Since it is limited to only when authentication is successfully completed that the authentication apparatus issues the program-update request, the request for updating a program from an unauthorized person can be cancelled by limiting the device which is authorized to receive the program update request to an authenticated device. Consequently, security associated with updating program can be improved.

According to one aspect of the present invention, a program update requester sends a program update request to a device to be updated after which the device to be updated sends the information of the program update requester included in the program update request which has been received to an external authentication device. The outside authentication device sends a program to the device to be updated when an authentication is successfully completed. Namely, since the device to be updated requests the external authentication device to conduct an authentication of the program update requester and the authentication device sends the update program only when the authentication is successfully completed, security associated with a program update can be assured.

According to one aspect of the present invention, a receiving device receives information of a program update requester and information of a device to be updated inputted via an external input device outside the device to be updated. And the judging device authenticates the requester of the program update request received by the receiving device. An updating device updates the program of the device to be updated specified by the program update request via a network only when the judging device successfully completes the authentication process.

The receiving device, the judging device and the updating device may be configured to any device in a program updating system or may be separately provided in a device to be updated, an authentication device and a program storage apparatus. Necessary information is exchanged via communication between those separately provided devices. The updating device may comprise a function to have the device to be updated prepare for program updating status and also a function to have the device to be updated actually update the program via network when the device to be updated is ready for the update. The two functions described above may be provided separately in different devices, for example, one in an authentication device and the other in a device to be updated.

What is claimed is:

1. A system for updating a program, comprising:
a device to be updated with an update-program based on a program-update request including information of a requester and information for specifying the device, generated by the requester; and
an authentication device which authenticates the requester,
wherein the authentication device includes
a receiving device which receives the program-update request;
a judging device which judges whether or not the information of the requester is identical with a pre-registered information; and
a transmitting device which transmits a program-update notice to the device based on the information for specifying the device only when the information of the requester is identical with the pre-registered information,
wherein the device to be updated is shifted into a status which can allow the device to update the program only when the device receives the program-update notice.

2. The system of claim 1, further comprising:
a program storage device which stores the update-program,
wherein the device obtains the update-program from the program storage device via a network when the device receives the program-update notice.

3. The system of claim 2, wherein the authentication device and the program storage device are integrally formed.

4. The system of claim 1, wherein the authentication device and the device to be updated are integrally formed.

5. The system of claim 1, wherein the authentication device stores the update-program and the device obtains the update-program from the authentication device via a network when the device receives the program-update notice.

6. The system of claim 1, wherein the program-update request is received via e-mail from the requester.

7. The system of claim 1, wherein the program-update request is generated based on an input in a web system by the requester.

8. The system of claim 1, wherein the program-update request is received via telephone network by the requester.

9. The system of claim 1, wherein the information of the requester includes an identification number of the requester and a password, and the judging device judges whether the identification number and the password are identical with the pre-registered information.

10. The system of claim 1, wherein the device notifies a result of a program updating process when the program updating process is completed.

11. The system of claim 10, wherein the device notifies a result of a program updating process to the requester.

12. A system for updating a program, comprising:
an authentication device; and
a device to be updated with an update-program based on a program-update request including information of a requester,
wherein the device comprises
a receiving device which receives the program-update request,
a first transmitting device which transmits the information of the requester to the authentication device,
wherein the authentication device having a pre-registered information which authenticates the requester, comprises
a judging device which judges whether or not the information of the requester received from the first transmitting device is identical with the pre-registered information, and
a second transmission device which transmits a program-update notice to the device only when the judging device judges that the information of the requester is identical with the pre-registered information,
wherein the device to be updated is shifted into a status which can allow the device to update the program only when the device receives the program-update notice.

13. The system of claim 12, wherein the authentication device stores the update-program and transmits the update-program to the device only when the judging device judges the information of requester is identical with the pre-registered information.

14. The system of claim 12, further comprising:
a program storage device which stores the update-program, wherein the program storage device transmits the update-program to the device via a network only when the judging device judges the information of requester is identical with the pre-registered information.

15. The system of claim 14, wherein the program-update notice is transmitted to the device via the program storage device.

16. The system of claim 14, wherein the update-program is transmitted to the device via the authentication device.

17. The system of claim 14, wherein the authentication device and the program storage device are integrally formed.

18. The system of claim 12, wherein the program-update request is received via e-mail from the requester.

19. The system of claim 12, wherein the program-update request is generated based on an input in a web system by the requester.

20. The system of claim 12,
wherein the program-update request is received via a telephone network by the requester.

21. The system of claim 12, wherein the information of the requester includes an identification number of the requester and a password, and the judging device judges whether the identification number and password are identical with the pre-registered information.

22. The system of claim 12, wherein the device notifies a result of a program updating process when the program updating process is completed.

23. The system of claim 22,
wherein, the device notifies a result of the program updating process to the requester.

24. A system for updating a program, the system comprising:
a program storage device which stores an update-program;
a device to be updated with an update-program based on a program-update request including information of a requester and information of the device;
a receiving device which receives the program-update request inputted in an external device at outside of the receiving device;
a judging device which judges whether or not the information of the requester received by the receiving device is identical with pre-registered information; and
a program updating device which controls so that the device to be updated downloads the update-program from the program storage device via the network only when the information of the requester is identical with the pre-registered information.

25. The system of claim 24, wherein the device to be updated includes the receiving device, the judging device and the program updating device.

26. The system of claim 24, wherein the program-update request is received via e-mail from the requester.

27. The system of claim 24, wherein the program-update request is generated based on an input on a web system by the requester.

28. The system of claim 24, wherein the program-update request is received via telephone network by the requester.

29. The system of claim 24, wherein the information of the requester includes an identification number of the requester and a password, and the judging device judges whether the identification number and the password are identical with the pre-registered information.

30. The system of claim 24, wherein the device notifies a result of a program updating process when the program updating process is completed.

31. The system of claim 30, wherein the device notifies a result of a program updating process to the requester.

32. A method for updating a program used in a device of a system including an authentication device for authenticating the requester, the method comprising the steps of:
receiving a program-update request including information of a requester;
judging whether or not the information of the requester is identical with a pre-registered information; and
allowing the device to be changed into a status which can allow the device to update the program only when the device receives the program-update notice the information of the requester is identical with the pre-registered information.

33. The method of claim 32, further comprising the step of: updating the program in the device to the updated-program via a network.

34. The method of claim 32, wherein the receiving step is executed in the authentication device.

35. The method of claim 34, further comprising the step of: transmitting a program-update notice for updating the program to the device after the judging step, wherein the allowing step is executed in the device which receives the program-update notice.

36. The method of claim 32, wherein the receiving step and the judging step are executed in the device.

37. The method of claim 32, wherein the program-update request is received via e-mail from the requester.

38. The method of claim 32, wherein the program-update request is generated based on an input on a we system by the requester.

39. The method of claim 32, wherein the program-update request is received via telephone network by the requester.

40. The method of claim 32, wherein the information of the requester in the program-update request includes an identification number of the requester and a password, and in the judging step, it is judged that the identification number and the password are identical with the pre-registered information or not.

41. The method of claim 32, further comprising a step of: notifying a result of a program updating process when the program updating process is completed.

42. The method of claim 41, wherein the result is notified to the requester.
